(19) United States
(12) Patent Application Publication
(10) Pub. No.: US 2025/0193894 A1
(43) Pub. Date: Jun. 12, 2025

(54) METHOD, DEVICE AND COMPUTER PROGRAM PRODUCT FOR WIRELESS COMMUNICATION

(71) Applicant: ZTE Corporation, Shenzhen (CN)

(72) Inventors: Youjun HU, Shenzhen (CN); Bo DAI, Shenzhen (CN); Mengzhu CHEN, Shenzhen (CN); Luanjian BIAN, Shenzhen (CN); Kun LIU, Shenzhen (CN); Weiwei YANG, Shenzhen (CN)

(21) Appl. No.: 19/039,747

(22) Filed: Jan. 28, 2025

Related U.S. Application Data
(63) Continuation of application No. PCT/CN2022/109214, filed on Jul. 29, 2022.

(51) Int. Cl. H04W 72/23; H04W 72/0446; H04W 72/0453

(52) U.S. Cl. CPC H04W 72/23; H04W 72/0446; H04W 72/0453

(57) ABSTRACT

Method, device and computer program product for wireless communication are provided. A method includes: receiving, by a second type wireless communication node from a first type wireless communication node, control information via repeatedly transmitted physical downlink control channels, PDCCHs, in one or more occasions.

### CROSS-REFERENCE TO RELATED APPLICATIONS

This application is a continuation of International Patent Application No. PCT/CN2022/109214, filed Jul. 29, 2022, the disclosure of which is incorporated herein by reference in its entirety.

### TECHNICAL FIELD

This document is directed generally to wireless communications, in particular to 5th generation (5G) or 6th generation (6G) wireless communication.

### BACKGROUND

The PDCCH (physical downlink control channel) may be used by a base station (BS) to transmit information to a UE (user equipment). For a UE with a relative narrow bandwidth, the reception of the PDCCH may have performance loss due to the uncompleted reception.

### SUMMARY

The present disclosure relates to methods, devices, and computer program products for the reception of the PDCCH.

One aspect of the present disclosure relates to a wireless communication method. In an embodiment, the wireless communication method includes: receiving, by a second type wireless communication node from a first type wireless communication node, control information via repeatedly transmitted physical downlink control channels, PDCCHs, in one or more occasions.

Another aspect of the present disclosure relates to a wireless communication method. In an embodiment, the wireless communication method includes: transmitting, by a first type wireless communication node to a second type wireless communication node, control information via repeatedly transmitted physical downlink control channels, PDCCHs, in one or more occasions.

Another aspect of the present disclosure relates to a second type wireless communication node (e.g., a user equipment). In an embodiment, the second type wireless communication node includes a communication unit and a processor. The processor is configured to: receive, from a first type wireless communication node, control information via repeatedly transmitted physical downlink control channels, PDCCHs, in one or more occasions.

Another aspect of the present disclosure relates to a first type wireless communication node (e.g., a base station). In an embodiment, the first type wireless communication node includes a communication unit and a processor. The processor is configured to: transmit, to a second type wireless communication node, control information via repeatedly transmitted physical downlink control channels, PDCCHs, in one or more occasions.

Various embodiments may preferably implement the following features:

Preferably, the repeatedly transmitted PDCCHs comprise Type0 PDCCHs, Type0A PDCCHs, Type0B PDCCHs, Type1 PDCCHs, or Type2 PDCCHs.

Preferably, the second type wireless communication node monitors the repeatedly transmitted PDCCHs on one or more slots periodically, or the second type wireless communication node assumes or expects the PDCCHs are repeatedly transmitted on the one or more slots periodically.

Preferably, the occasions are predetermined or determined based on at least one of slot n0 or slot n0+1 for the second type wireless communication node monitoring the PDCCHs in a Type0-PDCCH CSS set.

Preferably, the repeatedly transmitted PDCCHs can be transmitted on occasions in slot n0 associated to a same SSB (synchronization signal block) index in different SSB burst sets, or the repeatedly transmitted PDCCHs can be transmitted on occasions in slot n0+1 associated to a same SSB index in different SSB burst sets; or the repeatedly transmitted PDCCHs can be transmitted on occasions in slots n0 and n0+1 associated to a same SSB index in different SSB burst set.

Preferably, a search space set for transmitting the PDCCHs in at least one of slots n0 or n0+1 is predetermined, the second type wireless communication node assumed, the second type wireless communication node expected, or determined by one or more indications in at least one of a system information block, SIB, including SIB1, or a master information block, MIB.

Preferably, the PDCCHs are repeatedly transmitted on all search space sets based to a Synchronization Signal/PBCH (physical broadcast channel) block, SSB, index on the slot n₀ or n₀+1;

Preferably, a periodicity for the repeatedly transmitted PDCCHs is predetermined, the second type wireless communication node assumed, the second type wireless communication node expected, or determined by one or more indications in at least one of a system information block, SIB, including a system information block #1, SIB1, or a master information block, MIB.

Preferably, the periodicity indicated via the MIB or the SIB is larger than or equal to the periodicity of SSB for a cell.

Preferably, the second type wireless communication node monitors the repeatedly transmitted PDCCHs in different occasions according to at least one of:
one or more first indexes;
one or more PDCCH candidate; or
one or more aggregation levels, ALS;
wherein one of the first indexes comprise at least one of a Control Channel Element, CCE, index for an AL L, or an index offset i for the AL L, and i=0, . . . , L−1,
wherein one of the PDCCH candidates comprises m_{s,n}_{_{Cl}}^{(L)}, m_{s,n}_{_{Cl}}^{(L)}=0, . . . . M_{s,n}_{_{Cl}}^{(L)}−1, wherein M_{s,n}_{_{Cl}}^{(L)} is a number of PDCCH candidates the second type wireless communication node is configured to monitor for the aggregation level L of a search space set s for a serving cell corresponding to n_{Cl}.

Preferably, at least one of the first indexes, the PDCCH candidates, or the ALs for repeated PDCCH in different occasions are predetermined, the second type wireless communication node assumed, the second type wireless communication node expected, or determined by one or more indications in at least one of an SIB or an MIB.

Preferably, the second type wireless communication node monitors the repeatedly transmitted PDCCHs in different occasions with a same one of the first indexes, and a same one of the PDCCH candidates for the one or more AL.

Preferably, the second type wireless communication node monitors the repeatedly transmitted PDCCHs in different occasions with multiple same indexes from the first indexes, and multiple same candidates from the PDCCH candidates for the one or more ALs.

Preferably, the second type wireless communication node monitors the repeatedly transmitted PDCCHs in different occasions based on the one or more PDCCH candidates for the one or more ALs.

Preferably, the second type wireless communication node monitors the repeatedly transmitted PDCCHs in different occasions based on one or more same indexes from the first indexes for the one or more ALs.

Preferably, the second type wireless communication node monitors the repeatedly transmitted PDCCHs in different occasions with different ones of the first indexes, or different ones of the PDCCH candidates for the one or more AL.

Preferably, the repeatedly transmitted PDCCHs or PDCCH occasions are defined in a time window, wherein a length of the time window is predetermined, the second type wireless communication node assumed, the second type wireless communication node expected, or determined by one or more indications in at least one of an SIB or an MIB.

Preferably, the indications in the MIB may include at least one of an MIB reserved bit or a PBCH payload bit or MIB fields bits.

Preferably, the length of the time window comprises at least one of the following:
a period of time;
a period of time based on timer;
a period of time based on an SSB periodicity or 20 milliseconds;
a period of time based on a system frame number, SFN;
a period of time based on time unit of microsecond, millisecond, or second; or
a number of the one or more occasions for the repeatedly transmitted PDCCHs.

Preferably, the length of the time window is based on one or more indications in fields of the MIB.

Preferably, an aggregation level of a search space set for the repeatedly transmitted PDCCHs is predetermined, the second type wireless communication node assumed, the second type wireless communication node expected, or determined by one or more indications in at least one of an SIB or an MIB.

Preferably, the PDCCHs are assumed or expected or configured or indicated or predetermined to be transmitted every X unit time, where X unit time is based on half frames, a period of time, an SSB periodicity, a slot, milliseconds, microseconds, seconds, or an SFN, and X is an integer.

Preferably, an indication for activating or deactivating monitoring or decoding of the repeatedly transmitted PDCCHs is determined by one or more indications in at least one of an SIB or an MIB.

Preferably, an indication for activating or deactivating monitoring or decoding of the repeatedly transmitted PDCCHs is determined by at least one of the following conditions:
a bandwidth of a CORESET #0 is larger than a maximum channel bandwidth of the second type wireless communication node;
the maximum channel bandwidth of the second type wireless communication node is less than a system bandwidth or a transmission bandwidth;
and the second type wireless communication node is allowed to access to a network or a cell.

Preferably, the method further includes receiving, by the second type wireless communication node with a maximum channel bandwidth or a maximum physical resource block, PRB, numbers, a first part of a PDCCH in first defined symbols and a second part of the PDCCH in second defined symbols.

Preferably, a frequency location of the second part of the PDCCH is within the frequency location of the first part of the PDCCH.

Preferably, a bandwidth of the first part of the PDCCH and the second part of the PDCCH is no more than the maximum channel bandwidth of the second type wireless communication node or a PRB number of the first part of the PDCCH and the second part of the PDCCH is no more than the maximum PRB number of the second type wireless communication node.

Preferably, a third part of the PDCCH is defined in the first defined symbols and a frequency domain resource assignment, FDRA, of the first part of the PDCCH and the third part of the PDCCH is indicated via an MIB.

Preferably, a third part of the PDCCH is defined in the first defined symbols, and a frequency location of the third part of the PDCCH is different from a frequency location of the second part of the PDCCH.

Preferably, the frequency location of the second part of the PDCCH is the first M RBs in frequency indicated via an FDRA for the first part of the PDCCH and the third part of the PDCCH. Preferably, the last M RBs in frequency indicated via the FDRA, or preferably, M RBs in the middle in frequency indicated via the FDRA, wherein M is an integer.

Preferably, a time domain resource allocation, TDRA, indication, in downlink control information, DCI, carried in the PDCCHs, indicates a start symbol for the repeatedly transmitted PDCCHs is 2, 4, or an integer not less than 6.

Preferably, the first type wireless communication node transmits the control information via the repeatedly transmitted PDCCHs on one or more slots periodically.

Preferably, the occasions are predetermined or determined based on at least one of slot n0 or slot n0+1 for the first type wireless communication node transmitting the control information via the PDCCHs in a Type0-PDCCH CSS set.

Preferably, a search space set for transmitting the PDCCHs in at least one of slots n0 or n0+1 is predetermined or determined by one or more indications in at least one of a system information block, SIB, including SIB1, or a master information block, MIB.

Preferably, a periodicity for the repeatedly transmitted PDCCHs is predetermined or determined by one or more indications in at least one of a system information block, SIB, including a system information block #1, SIB1, or a master information block, MIB.

Preferably, the first type wireless communication node transmits the control information via the repeatedly transmitted PDCCHs in different occasions according to at least one of:
one or more first indexes;
one or more PDCCH candidate; or
one or more aggregation levels, ALS;
wherein one of the first indexes comprise at least one of a Control Channel Element, CCE, index for an AL L, or an index offset i for the AL L, and i=0, . . . , L−1,
wherein one of the PDCCH candidates comprises m_{s,n}_{_{Cl}}^{(L)}, m_{s,n}_{_{Cl}}^{(L)}=0, . . . , M_{s,n}_{_{Cl}}^{(L)}−1, wherein M_{s,n}_{_{Cl}}^{(L)} is a number of PDCCH candidates the first type wireless communication node is configured to transmits the control information for the aggregation level L of a search space set s for a serving cell corresponding to n_{Cl}.

Preferably, at least one of the first indexes, the PDCCH candidates, or the ALs for repeated PDCCH in different occasions are predetermined or determined by one or more indications in at least one of an SIB or an MIB.

Preferably, the first type wireless communication node transmits the control information via the repeatedly transmitted PDCCHs in different occasions with a same one of the first indexes, and a same one of the PDCCH candidates for the one or more AL.

Preferably, the first type wireless communication node transmits the control information via the repeatedly transmitted PDCCHs in different occasions with multiple same indexes from the first indexes, and multiple same candidates from the PDCCH candidates for the one or more ALs.

Preferably, the first type wireless communication node transmits the control information via the repeatedly transmitted PDCCHs in different occasions based on the one or more PDCCH candidates for the one or more ALs.

Preferably, the first type wireless communication node transmits the control information via the repeatedly transmitted PDCCHs in different occasions based on one or more same indexes from the first indexes for the one or more ALs.

Preferably, the first type wireless communication node transmits the control information via the repeatedly transmitted PDCCHs in different occasions with different ones of the first indexes, or different ones of the PDCCH candidates for the one or more AL.

Preferably, the repeatedly transmitted PDCCHs or PDCCH occasions are defined in a time window, wherein a length of the time window is predetermined or determined by one or more indications in at least one of an SIB or an MIB.

Preferably, an aggregation level of a search space set for the repeatedly transmitted PDCCHs is predetermined or determined by one or more indications in at least one of an SIB or an MIB.

Preferably, the method further includes: transmitting, by the first type wireless communication node to the second type wireless communication node with a maximum channel bandwidth or a maximum physical resource block, PRB, numbers, a first part of a PDCCH in first defined symbols and a second part of the PDCCH in second defined symbols.

Preferably, a frequency location of the second part of the PDCCH is within the frequency location of the first part of the PDCCH.

Preferably, a bandwidth of the first part of the PDCCH and the second part of the PDCCH is no more than the maximum channel bandwidth of the second type wireless communication node or a PRB number of the first part of the PDCCH and the second part of the PDCCH is no more than the maximum PRB number of the second type wireless communication node.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a diagram of an arrangement of resource blocks according to an embodiment of the present disclosure.

FIG. 2 shows a diagram of an arrangement of resource blocks according to another embodiment of the present disclosure.

FIG. 3 shows a diagram of an arrangement of resource blocks according to another embodiment of the present disclosure.

FIG. 4 shows a diagram of a time domain resource allocation according to another embodiment of the present disclosure.

FIG. 5 shows a schematic diagram of a wireless communication terminal according to an embodiment of the present disclosure.

FIG. 6 shows a schematic diagram of a wireless communication node according to an embodiment of the present disclosure.

### DETAILED DESCRIPTION

In some embodiments, the second type wireless communication node comprises at least one of a UE, a RedCap (reduced capability) UE and/or a type of UE or some types of UE.

In some embodiments, the first type wireless communication comprises at least one of a base station, a gNB, an eNB, a repeater, and so on.

In some embodiments, the MIB indication bits comprise at least one of the reserved bits in the MIB, the fields in the MIB and/or PBCH payload bits.

In some embodiments, the PBCH payload bits comprise a 6, a-47.

In the present disclosure, when an operation “monitoring” is mentioned, it can be understood as the operations of monitoring, decoding, and/or combining is/are performed, unless otherwise specified. For example, a phrase “the UE monitors the repeated transmitted PDCCHs” can be understood as “the UE monitors, combines or decodes the repeated transmitted PDCCHs”.

In some embodiments, a set of PDCCH candidates for a UE may be defined in terms of PDCCH search space sets. A search space set can be a CSS (Common Search Space) set or a USS (UE specific Search Space) set. A UE monitors the PDCCH candidates in one or more of the following search spaces sets:
a Type0-PDCCH CSS set configured by the pdcch-ConfigSIB1 in the MIB (Master Information Block) or by the searchSpaceSIB1 in the PDCCH-ConfigCommon or by the searchSpaceZero in the PDCCH-ConfigCommon for a DCI (Downlink Control Information) format 1_0 with the CRC (cyclic redundancy check) scrambled by an SI-RNTI (System Information-Radio Network Temporary Identifier), or by the searchSpaceZero in the PDCCH-ConfigCommon when the pdcch-Config-MCCH or the pdcch-Config-MCCH is not provided, for a DCI format with CRC scrambled by a MCCH-RNTI (MBS (Multicast and Broadcast Services) Control Channel-Radio Network Temporary Identifier) or a G-RNTI (Group-Radio Network Temporary Identifier), on the primary cell of the MCG (Master Cell Group);
a Type0A-PDCCH CSS set configured by the searchSpaceOtherSystemInformation in the PDCCH-ConfigCommon for a DCI format 1_0 with the CRC scrambled by a SI-RNTI on the primary cell of the MCG;
a TypeOB-PDCCH CSS set configured by the searchSpaceBroadcast in the pdcch-Config-MCCH and the pdcch-Config-MTCH for a DCI format with CRC scrambled by a MCCH-RNTI or a G-RNTI, on the primary cell of the MCG;
a Type1-PDCCH CSS set configured by the ra-SearchSpace in the PDCCH-ConfigCommon for a DCI format 1_0 with the CRC scrambled by a RA-RNTI, a MsgB-RNTI, or a TC-RNTI (Temporary C-RNTI) on the primary cell; and/or
a Type2-PDCCH CSS set configured by the pagingSearchSpace in the PDCCH-ConfigCommon for a DCI format 1_0 with the CRC scrambled by a P-RNTI (Paging RNTI) on the primary cell of the MCG.

In some embodiments, for the operation without the shared spectrum channel access and for the SS/PBCH block (SSB) and CORESET (control-resource set) multiplexing pattern 1, a UE monitors the PDCCH in the Type0-PDCCH CSS set over two slots n₀. For the SS/PBCH block with an index i, the UE determines the slot n₀ as n₀=(O·2^{μ}+[i·M])modNₛₗₒₜ^{frame,μ}, in which the slot n₀ is in a frame with a system frame number (SFN) SFNcsatisfying SFN_{c}mod2=0 if [O·2^{μ}+[i·M)/Nₛₗₒₜ^{frame,μ}] mod2=0, or in a frame with an SFN SFN_{c}satisfying SFN_{c}mod2=1 if (O·2^{μ}+[i·M])/Nₛₗₒₜ^{frame,μ}] mod2=1, wherein μ ∈{0,1,2,3,5,6} based on the SCS for the PDCCH slot receptions in the CORESET.

In some embodiments, for μ ∈{0,1,2,3} and for an SS/PBCH block index i, the two slots including the associated Type0-PDCCH monitoring occasions are slots n₀ and n₀+1. M, 0, and the index of the first symbol of the CORESET in slots n₀ and n₀+1 are provided by the table below.

| | | Number of search space | | |
|---|---|---|---|---|
| Index | O | sets per slot | M | First symbol index |
| 0 | 0 | 1 | 1 | 0 |
| 1 | 0 | 2 | 1/2 | {0, if i is even}, |
| | | | | {N_{symb}^{CORESET}, if i is odd} |
| 2 | 2 | 1 | 1 | 0 |
| 3 | 2 | 2 | 1/2 | {0, if i is even}, |
| | | | | {N_{symb}^{CORESET}, if i is odd} |
| 4 | 5 | 1 | 1 | 0 |
| 5 | 5 | 2 | 1/2 | {0, if i is even}, |
| | | | | {N_{symb}^{CORESET}, if i is odd} |
| 6 | 7 | 1 | 1 | 0 |
| 7 | 7 | 2 | 1/2 | {0, if i is even}, |
| | | | | {N_{symb}^{CORESET}, if i is odd} |
| 8 | 0 | 1 | 2 | 0 |
| 9 | 5 | 1 | 2 | 0 |
| 10 | 0 | 1 | 1 | 1 |
| 11 | 0 | 1 | 1 | 2 |
| 12 | 2 | 1 | 1 | 1 |
| 13 | 2 | 1 | 1 | 2 |
| 14 | 5 | 1 | 1 | 1 |
| 15 | 5 | 1 | 1 | 2 |

In some embodiments, for Lₘₐₓ>4, in which Lₘₐₓ is the maximum number of SSBs within a SSB set, the UE determines the 3 LSB (least significant bit) bits of a candidate SS/PBCH block index per half frame from a one-to-one mapping with an index of the DM-RS (demodulation reference signal) sequence transmitted in the PBCH (Physical broadcast channel).

In some embodiments, for Lₘₐₓ=10, the UE determines the 1 MSB (most significant bit) bit of the candidate SS/PBCH block index from the PBCH payload bit ā_{Ā+7}.

In some embodiments, for Lₘₐₓ=20, the UE determines the 2 MSB bits of the candidate SS/PBCH block index from the PBCH payload bits ā_{Ā+6}, ā_{Ā+7}.

In some embodiments, for Lₘₐₓ=64, the UE determines the 3 MSB bits of the candidate SS/PBCH block index from the PBCH payload bits ā_{Ā+5}, ā_{Ā+6}, ā_{Ā+7}.

Many embodiments of the present disclosure are described below, but the present disclosure is not limited there to.

### Embodiment 1

In an embodiment, the PDCCHs are repeatedly transmitted. In an embodiment, the PDCCH includes a Type0-PDCCH, a Type0A-PDCCH, a TypeOB-PDCCH, a Type1-PDCCH, or a Type2-PDCCH.

In an embodiment, the UE may monitor one or more PDCCHs occasions for receiving the repeatedly transmitted PDCCHs. In an embodiment, the UE may decode/monitor/combine multiple repeated PDCCHs to improve decoding performance.

### Embodiment 1.1: Predefined Repeated PDCCH Transmission

In an embodiment, a gNB (gNodeB) may transmit the repeatedly transmitted PDCCHs in slots n₀ and/or n₀+1. In an embodiment, a UE may assume or expect the repeatedly transmitted PDCCHs would be transmitted in slots n₀ and/or n₀+1, and monitor PDCCH in slots n₀ and/or n₀+1.

In an embodiment, the second type wireless communication node monitors, combines, and/or decodes the repeatedly transmitted PDCCHs on one or more slots periodically, or the second type wireless communication node assumes or expects the PDCCHs are repeatedly transmitted on the one or more slots periodically.

In an embodiment, the repeatedly transmitted PDCCHs can be transmitted on occasions in slot n0 associated to a same SSB index in different SSB burst sets, or the repeatedly transmitted PDCCHs can be transmitted on occasions in slot n0+1 associated to a same SSB index in different SSB burst sets; or the repeatedly transmitted PDCCHs can be transmitted on occasions in slots n0 and n0+1 associated to a same SSB index in different SSB burst set.

In an embodiment, a search space set for transmitting the PDCCHs in at least one of slots n0 or n0+1 is predetermined, the second type wireless communication node assumed, the second type wireless communication node expected, or determined by one or more indications in at least one of a system information block, SIB, including SIB1, or a master information block, MIB.

In an embodiment, the repeated PDCCH is transmitted on the first search space set for slot n0 associated to a same SSB index in different SSB burst sets. Based on the periodicity of SSB equal to 20 ms, the periodicity of PDCCH repetition is one of 20 ms, 40 ms, 80 ms or more, where periodicity of PDCCH repetition is no less than the periodicity of SSB.

In an embodiment, the repeated PDCCH is transmitted on the first search space set for slot n0 associated to a same SSB index in different SSB burst sets. The periodicity of PDCCH repetition is one of 10 ms, 20 ms, 40 ms, 80 ms or more.

In an embodiment, 1 bit in SIB1/MIB to indicate that the periodicity of PDCCH repetition is 20 ms in slot n0.

In an embodiment an aggregation level of a search space set for the repeatedly transmitted PDCCHs is predetermined, the second type wireless communication node assumed, the second type wireless communication node expected, or determined by one or more indications in at least one of an SIB or an MIB.

In an embodiment, AL-4, 8 or 16, is used for repeated PDCCH. The first indexes and/PDCCH candidates may be different or same.

In an embodiment, AL-4, 8 or 16, is used for repeated PDCCH. The first indexes and first PDCCH candidate is used to transmit the repeated PDCCH in slot n0 for a SSB index in a SSB burst set or in a cycle of periodicity of PDCCH repetition.

In an embodiment, SIB1/MIB indicate the AL for repeated PDCCH. For example, 1 bits indicate {4,8}, or {2,4}. For example, 2 bits indicate {1,2,4,8} or {2,4,8,16}. Or 3bits in SIB1MIB is used.

In an embodiment, a gNB (gNodeB) may transmit the repeatedly transmitted PDCCHs in slots n₀ and/or n₀+1 every X ms (millisecond). In an embodiment, a UE may assume or expect the repeatedly transmitted PDCCHs would be transmitted in slots n₀ and/or n₀+1 every X ms, and monitor slots n₀ and/or n₀+1 every X ms, and X is an integer.

In an embodiment, the PDCCHs are assumed or expected or configured or indicated or predetermined to be transmitted every X unit time, where X unit time is based on half frames, a period of time, an SSB periodicity, a slot, milliseconds, microseconds, seconds, or an SFN, and X is an integer. E.g., X can be 5, 10, 15, 20, 40, or 80.

In an embodiment, for the SS/PBCH block with index i, the UE may determine an index of slot n₀ as n₀=(O·2^{μ}+[i·M])modNₛₗₒₜ^{frame,μ} that is in a frame with system frame number (SFN) SFN_{c}satisfying SFN_{c}mod2=0 if [(O·2^{μ}+[i·M])/Nₛₗₒₜ^{frame,μ}]mod2=0, or in a frame with SFN_{c}satisfying SFN_{c}mod2=1 if [(O·2^{μ}+[i·M])/Nₛₗₒₜ^{frame,μ}]mod2=1 where μ ε{0,1,2,3,5,6} based on the SCS for PDCCH receptions in slot the CORESET, and M, O, and the index of the first symbol of the CORESET in slots n₀ and n₀+1 are provided by Table 13-11.

TABLE 13-11
Parameters for PDCCH monitoring occasions
for Type0-PDCCH CSS set - SS/PBCH block
and CORESET multiplexing pattern 1 and FR1|

| | | Number of search space | | |
|---|---|---|---|---|
| Index | O | sets per slot | M | First symbol index |
| 0 | 0 | 1 | 1 | 0 |
| 1 | 0 | 2 | 1/2 | {0, if i is even}, |
| | | | | {N_{symb}^{CORESET}, if i is odd} |
| 2 | 2 | 1 | 1 | 0 |
| 3 | 2 | 2 | 1/2 | {0, if i is even}, |
| | | | | {N_{symb}^{CORESET}, if i is odd} |
| 4 | 5 | 1 | 1 | 0 |
| 5 | 5 | 2 | 1/2 | {0, if i is even}, |
| | | | | {N_{symb}^{CORESET}, if i is odd} |
| 6 | 7 | 1 | 1 | 0 |
| 7 | 7 | 2 | 1/2 | {0, if i is even}, |
| | | | | {N_{symb}^{CORESET}, if i is odd} |
| 8 | 0 | 1 | 2 | 0 |
| 9 | 5 | 1 | 2 | 0 |
| 10 | 0 | 1 | 1 | 1 |
| 11 | 0 | 1 | 1 | 2 |
| 12 | 2 | 1 | 1 | 1 |
| 13 | 2 | 1 | 1 | 2 |
| 14 | 5 | 1 | 1 | 1 |
| 15 | 5 | 1 | 1 | 2 |

In an embodiment, Xms may be 20 ms, 40 ms, 80 ms, 10 ms, 5 ms or has the same periodicity with SIB1 (system information block #1), SSB, PBCH (Physical Broadcast Channel), and/or the periodicity of the SSB in the serving cell (e.g., ssb-periodicityServingCell).

### Embodiment 1.2

In an embodiment, the PDCCHs may be repeatedly transmitted on Predefined (CCE) index and/or numbered candidate for an aggregation level L of a search space set s for a serving cell. For example, the UE may expect the repeatedly transmitted PDCCHs can be transmitted on a predefined numbered candidate and/or with a (CCE) index for an AL of a search space. Then, the UE may monitor/decode/combine the PDCCH in different occasions with the first index and/or the same numbered candidate m_{s,n}_{_{Cl}}^{(L)}.

In an embodiment, the first index may include that the CCE index and an index offset i, in which the CCE index according to:

$$L \cdot \{ ( {Y}_{p , {n}_{s , f}^{μ}} + ⌊ \frac{{m}_{s , {n}_{CI} \cdot {N}_{CCE , p}}^{( L )}}{L \cdot {M}_{s , max}^{( L )}} ⌋ + {n}_{CI} ) mod ⌊ {N}_{CCE , p} / L ⌋ \} + i ,$$

in which i is the index offset, i=0, . . . , L−1, Y_{p,n}_{_{s,f}}_{^{μ}} is candidate, m_{s,n}_{_{Cl}}^{(L)}=0, . . . , M_{s,n}_{_{Cl}}^{(L)}−1, and M_{s,n}_{_{Cl}}^{(L)} is a number of PDCCH candidates the UE is configured to monitor for the aggregation level L of a search space set s for a serving cell corresponding to n_{cl}. And N_{CCE,p} is the number of CCEs in CORESET p and, if any, per RB set.

Y_{p,n}_{_{s,f}}_{^{μ}} is as below:
for any CSS, Y_{p,n}_{_{s,f}}_{^{μ}}=0;
for a USS. Y_{p,n}_{_{s,f}}_{^{μ}}=(Aₚ·Y_{p,n}_{_{s,f}}_{^{μ}}−1)modD, Y_{p,-1}=n_{RNTI}≠0, Aₚ=39827 for pmod3=0, Aₚ=39829 for pmod3=1, Aₚ=39839 for pmod3=2, and D=65537;|

In an embodiment, the gNB may transmit the repeatedly transmitted PDCCHs in different occasions with a first index and a numbered candidate m_{s,n}_{_{Cl}}^{(L)}. In an embodiment, the UE may assume that the UE may monitor/decode/combine the PDCCH in different occasions with a first index and a numbered candidate m_{s,n}_{_{Cl}}^{(L)}. For example, for different PDCCH occasion, the (repeated) PDCCH may only be transmitted based on the predefined a first index and a numbered candidate. Further, the first index can be the index offset i=0 or CCE index=0 or 1, and the numbered candidate can be m_{s,n}_{_{Cl}}^{(L)}=0.

In an embodiment, the UE may assume the repeatedly transmitted PDCCHs can be decoded on the first candidate for each AL with the index offset i=1 or 0. In an embodiment, the UE may assume the repeatedly transmitted PDCCHs can be decoded on the first candidate for each AL with the CCE index=0.

In an embodiment, for different PDCCH occasions, the PDCCH may only be transmitted based on the predefined first indexes and numbered candidates. Further, for different PDCCH occasions, the UE may monitor/decode/combine the PDCCH repeated transmitted with the same first index and numbered candidate, wherein the first index can be at least one of i, (i=0, 1, 2, 3) or CCE index (CCE index=0, 1, 2, 3), and the numbered candidate can be m_{s,n}_{_{Cl}}^{(L)}=0, 1.

In an embodiment, the gNB may transmit the PDCCH (the UE may assume that UE can monitor/decode/combine the repeatedly transmitted PDCCHs) in different, (L) occasion with several indexes and several numbered candidates m_{s,n}_{_{Cl}}^{(L)}, where m_{s,n}_{_{Cl}}^{(L)}=(L) 0, . . . , M_{s,n}_{_{Cl}}^{(L)}−1, where M_{s,n}_{_{Cl}}^{(L)} is the number of the PDCCH candidates the UE is configured to monitor for the aggregation level L of a search space set s for a serving cell corresponding to n_{Cl}; and the CCE index is derived according to the following formula:

$$L \cdot \{ ( {Y}_{p , {n}_{s , f}^{μ}} + ⌊ \frac{{m}_{s , {n}_{CI} \cdot {N}_{CCE , p}}^{( L )}}{L \cdot {M}_{s , max}^{( L )}} ⌋ + {n}_{CI} ) mod ⌊ {N}_{CCE , p} / L ⌋ \} + i .$$

In an embodiment, for different PDCCH occasions, the PDCCH may be transmitted on the predefined first indexes and numbered candidates. Further, for different PDCCH occasions, UE may monitor/decode/combine the PDCCH with the same or different first index and numbered candidate.

In an embodiment, the gNB may transmit the repeatedly transmitted PDCCHs in different occasions based on a first index or different first indexes.

In an embodiment, the gNB may transmit the repeatedly transmitted PDCCHs in different occasions based on a numbered candidate or different numbered candidates.

In an embodiment, the periodicity for the PDCCH repetition may be 20 ms.

In an embodiment, the PDCCH occasions may be assumed in slots n₀ or n₀+1.

In an embodiment, the PDCCH occasions may be assumed in symbol {0, N_{symb}^{CORESET}, 1, 2} in slot n₀ or n₀+1.

In an embodiment, the assumed symbols for the PDCCH occasions are determined according to the index indication as shown in the following table. For example, as illustrated in the table below, for index=1,3,5,7, the assumed symbols for the PDCCH occasions are 0 or N_{symb}^{CORESET}.

| | | Number of search space | | |
|---|---|---|---|---|
| Index | O | sets per slot | M | First symbol index |
| 0 | 0 | 1 | 1 | 0 |
| 1 | 0 | 2 | 1/2 | {0, if i is even}, |
| | | | | {N_{symb}^{CORESET}, if i is odd} |
| 2 | 2 | 1 | 1 | 0 |
| 3 | 2 | 2 | 1/2 | {0, if i is even}, |
| | | | | {N_{symb}^{CORESET}, if i is odd} |
| 4 | 5 | 1 | 1 | 0 |
| 5 | 5 | 2 | 1/2 | {0, if i is even}, |
| | | | | {N_{symb}^{CORESET}, if i is odd} |
| 6 | 7 | 1 | 1 | 0 |
| 7 | 7 | 2 | 1/2 | {0, if i is even}, |
| | | | | {N_{symb}^{CORESET}, if i is odd} |
| 8 | 0 | 1 | 2 | 0 |
| 9 | 5 | 1 | 2 | 0 |
| 10 | 0 | 1 | 1 | 1 |
| 11 | 0 | 1 | 1 | 2 |
| 12 | 2 | 1 | 1 | 1 |
| 13 | 2 | 1 | 1 | 2 |
| 14 | 5 | 1 | 1 | 1 |
| 15 | 5 | 1 | 1 | 2 |

In an embodiment, the time window is 20 ms, 40 ms, or 80 ms, wherein the time window is used for UE decoding/monitoring/combining repeatedly transmitted PDCCHs in a time duration.

In an embodiment, the number of PDCCH occasions may be one of following, {1, 2, 4, 8}, where the number of PDCCH occasions may be assumed for UE decoding/monitoring/combining repeatedly transmitted PDCCHs.

In an embodiment, the UE may assume that AL is 4, or 8 or 16 for decoding/monitoring/combining repeatedly transmitted PDCCHs.

### Embodiment 2

In an embodiment, a periodicity for the repeatedly transmitted PDCCHs is predetermined, the second type wireless communication node assumed, the second type wireless communication node expected, or determined by one or more indications in at least one of a system information block, SIB, including a system information block #1, SIB1, or a master information block, MIB.

In an embodiment, the SIB, SIB1, MIB, and/or PBCH payload may indicate the repetition periodicity (e.g., the periodicity of the repeatedly transmitted PDCCHs).

In an embodiment, the periodicity indicated via the MIB or the SIB is larger than or equal to the periodicity of SSB for a cell.

In an embodiment, 1 bit, 2 bits or 3 bits may be used in the SIB, SIB1, MIB, and/or PBCH payload to indicate the periodicity for PDCCH repetition periodicity (e.g., for the UE to monitor or decode the PDCCH occasions and monitor/decode/combine the PDCCHs), indicating at least one of {5 ms, 10 ms, 20 ms, 40 ms, 80 ms}. For example:
1 bit example: indicate {20 ms, 40 ms};
2 bits example: indicate {10 ms, 20 ms, 40 ms, 80 ms};
3 bits example: indicate {5 ms, 10 ms, 20 ms, 40 ms, 80 ms, 160 ms, spared, spared}.

In an embodiment, the periodicity for UE decoding/monitoring/combining the PDCCHs may be less or equal than the periodicity of the SSB periodicity indicated by the ssb-periodicityServingCell.

In an embodiment, the UE may assume that the PDCCHs are transmitted with default 20 ms periodicity.

In an embodiment, 1 or 2 bits are used in the SIB, SIB1, MIB, and/or PBCH payload to indicate the decoding pattern.

In an embodiment, 1 bit in the SIB1 may be used to indicate whether repeatedly transmitted PDCCHs will be transmitted or whether UE may expect the repeatedly transmitted PDCCHs. For example, value 1 may indicate that the UE can expect and/or monitor the PDCCHs in the predefined, configured, and/or indicated occasions and value 0 may indicate that the UE does not need to expect and/or monitor the repeatedly transmitted PDCCHs.

In an embodiment, 2 bits in the SIB, SIB1, MIB, and/or PBCH payload may be used to indicate the decoding pattern. For example, 11 may indicate that the UE can expect and/or monitor the PDCCH in slots n₀ and n₀+1. For example, 10 may indicate that the UE can expect and/or monitor the PDCCH in slots n₀ or n₀+1. For example, 01 may indicate that the UE can expect and/or monitor the PDCCH in slots n₀+1 or n₀. For example, 00 may indicate that the UE does not need to expect and/or monitor the repeatedly transmitted PDCCHs.

In an embodiment, 1 bit, 2 bits or 3 bits may be used in the SIB, SIB1, MIB, and/or PBCH payload to indicate the length of time window for the UE monitoring or decoding the PDCCH occasions for decoding/monitoring/combining the repeated transmitted PDCCHs, and the length of time window may include at least one of {5 ms, 10 ms, 20 ms, 40 ms, 80 ms, 160 ms}.

In an embodiment, 1 bit, 2 bits or 3 bits may be used in the SIB, SIB1, MIB, and/or PBCH payload to indicate the number of PDCCH occasions for PDCCH decoding/monitoring/combining, and the number of PDCCH occasions include at least one of {1, 2, 4, 6, 8, 10, 12, 16, 32}. The number of the PDCCH occasions for PDCCH decoding/monitoring/combining may be no more than 32. For example:
1 bit in the SIB, SIB1, MIB, and/or PBCH payload can indicate {2, 4} (if this parameter is absent, it may indicate no PDCCH occasion combination); and
2 bits in the SIB, SIB1, MIB, and/or PBCH payload can indicate {2, 4, 8, 16} (if this parameter is absent, it may indicate no PDCCH occasion combination).

In an embodiment, based on 5 ms half frame (i.e., 5 ms for each half frame), 32bits in the SIB may be used to indicate which half frame may transmit the PDCCHs and the UE may monitor the PDCCHs in that half frame.

In an embodiment, based on 20 ms half frame, each bit of 8bits in SIB may be used to indicate which half frame may transmit the PDCCH and the UE may monitor the PDCCHs in that half frame.

In an embodiment, based on the SSB periodicity (e.g., the ssb-periodicityServingCell), the number of bits may be a number equal to 160 divided the SSB periodicity. Each bit may indicate whether this PDCCH may be decoded/monitored in this half frame with the SSB burst set. For example:
if the ssb-periodicityServingCell=40 ms, the bitmap size may be 4 bits. Each bit of the 4 bits in the SIB1 may be used to indicate whether the PDCCHs will be transmitted in the half frame with the SSB burst.
if the ssb-periodicityServingCell-20 ms, bitmap size may be 8 bits. Each bit of the 8 bits in the SIB1 may be used to indicate whether the PDCCHs will be transmitted in the half frame with the SSB burst.

In an embodiment, the SIB, SIB1, MIB, and/or MIB payload may indicate the repeated PDCCH transmission including at least one of the numbered candidate(s), the (CCE) index(es), the PDCCH occasion(s), the decoding window, the decoding pattern, the AL, for the PDCCHs.

In an embodiment, the second type wireless communication node monitors, combines, and/or decodes the repeatedly transmitted PDCCHs in different occasions according to at least one of:
one or more first indexes;
one or more PDCCH candidate; or
one or more aggregation levels, ALS;
wherein one of the first indexes comprise at least one of a Control Channel Element, CCE, index for an AL L, or an index offset i for the AL L, and i=0, . . . , L−1,
wherein one of the PDCCH candidates comprises m_{s,n}_{_{Cl}}, m_{s,n}_{_{Cl}}=0, . . . , M_{s,n}_{_{Cl}}^{(L)}−1, wherein M (L) is a number of PDCCH candidates the second type wireless communication node is configured to monitor for the aggregation level L of a search space set s for a serving cell corresponding to n_{Cl}.

In an embodiment, the SIB, SIB1, MIB, and/or PBCH payload may indicate the following for repeated PDCCH:
1˜4bits for one or more first indexes;
1˜4bits for one or more PDCCH candidate; and/or
1˜3bits for one or more aggregation levels, ALs.

In an embodiment, X bits in the SIB, SIB1, MIB, and/or PBCH payload may indicate the first indexes, PDCCH candidate, and/or ALs, X >=0.

In an embodiment, at least one of the first indexes, the PDCCH candidates, or the ALs for repeated PDCCH in different occasions are predetermined, the second type wireless communication node assumed, the second type wireless communication node expected, or determined by one or more indications in at least one of an SIB or an MIB.

In an embodiment, the second type wireless communication node monitors, combines, and/or decodes the repeatedly transmitted PDCCHs in different occasions with a same one of the first indexes, and a same one of the PDCCH candidates for the one or more AL.

In an alternative embodiment, the second type wireless communication node monitors, combines, and/or decodes the repeatedly transmitted PDCCHs in different occasions with multiple same indexes from the first indexes, and multiple same candidates from the PDCCH candidates for the one or more ALs.

In an alternative embodiment, the second type wireless communication node monitors, combines, and/or decodes the repeatedly transmitted PDCCHs in different occasions based on the one or more PDCCH candidates for the one or more ALs.

In an alternative embodiment, the second type wireless communication node monitors, combines, and/or decodes the repeatedly transmitted PDCCHs in different occasions based on one or more same indexes from the first indexes for the one or more ALs.

In an embodiment, the second type wireless communication node monitors, combines, and/or decodes the repeatedly transmitted PDCCHs in different occasions with different ones of the first indexes, or different ones of the PDCCH candidates for the one or more AL.

In an embodiment, for each occasion for PDCCH decoding/monitoring/combining, the SIB, SIB1, MIB, and/or PBCH payload may indicate the numbered candidates. The UE may monitor/decode/combine the PDCCHs received based on the same numbered candidates (candidate index) for an AL of type0 CSS.

| CCE Aggregation Level | Number of Candidates |
|---|---|
| 4 | 4 |
| 8 | 2 |
| 16 | 1 |

For example:
for AL-4, 2 bits may be used to indicate which candidate index in {0, 1, 2, 3} is selected for PDCCH decoding/monitoring/combining and/or 2 bits may be used to indicate which first index {0, 1, 2, 3} is selected for PDCCH decoding/monitoring/combining;
for AL=4, 4 bits bitmap may be used to indicate which candidate indexes in {0, 1, 2, 3} are selected for PDCCH decoding/monitoring/combining and/or 4 bits bitmap may be used to indicate which first index {0, 1, 2, 3} is selected for PDCCH decoding/monitoring/combining;
for AL=8, 1 bit or 2 bits bitmap may be used to indicate which candidate indexes in {0, 1} are selected for PDCCH decoding/monitoring/combining, and/or 3 bits may be used to indicate which first index is used; and/or
for AL16, candidate index 0 may be assumed for PDCCH decoding/monitoring/combining, and/or 4 bits may be used to indicate which first index is used.

In an embodiment, all the case described above, may be indicated by a bitmap, e.g., a 7 bitmap as illustrated in the table below.

| | | | | | | |
|---|---|---|---|---|---|---|
| 1 bit for | 1 bit for | 1 bit for | 1 bit for | 1 bit for | 1 bit for | 1 bit (for |
| candidate | candidate | candidate | candidate | candidate | candidate | candidate |
| index 0 | index 1 | index 2 | index 3 | index 0 | index 1 | index 0) |

| | | |
|---|---|---|
| For AL = 4 | For AL = 8 | For AL = 16 |

In an embodiment, for each occasion for PDCCH decoding/monitoring/combining, SIB/SIB1/MIB and or PBCH payload may indicate the (CCE) index. The UE may monitor/decode/combine the PDCCHs received based on the same (CCE) index for an AL of type0 CSS. For example:
for AL=4, 2 bits may be used to indicate which (CCE) index (e.g., the same as the first index) in {0, 1, 2, 3} is selected for PDCCH decoding/monitoring/combining;
for AL=4, a 4-bit bitmap may be used to indicate which indexes in {0, 1, 2, 3} with an offset A are selected for PDCCH decoding/monitoring/combining;
for AL=8, a 8-bit bitmap or 3 bits may be used to indicate which indexes between 0 to 7 with an offset A are selected for decoding/monitoring/combining; and/or
for AL16, a 16-bit bitmap or 4 bits may be used to indicate which candidate index between 0 to 15 with an offset A for PDCCH decoding/monitoring/combining. A is an offset determined according to the following formula:

$$L \cdot \{ ( {Y}_{p , {n}_{s , f}^{μ}} + ⌊ \frac{{m}_{s , {n}_{CI} \cdot {N}_{CCE , p}}^{( L )}}{L \cdot {M}_{s , max}^{( L )}} ⌋ + {n}_{CI} ) mod ⌊ {N}_{CCE , p} / L ⌋ \} .$$

The parameters in this formula can be ascertained by the embodiments described above, and will not be repeated herein.

In an embodiment, the repeatedly transmitted PDCCHs or PDCCH occasions are defined in a time window, wherein a length of the time window is predetermined, the second type wireless communication node assumed, the second type wireless communication node expected, or determined by one or more indications in at least one of an SIB or an MIB.

In an embodiment, wherein the length of the time window comprises at least one of the following:
a period of time;
a period of time based on timer;
a period of time based on an SSB periodicity or 20 milliseconds;
a period of time based on a system frame number, SFN;
a period of time based on time unit of microsecond, millisecond, or second; and/or
a number of the one or more occasions for the repeatedly transmitted PDCCHs.

In an embodiment, the length of the time window is based on one or more indications in fields of the MIB.

In an embodiment, the length of the time window comprises {5, 10 15, 20, 40, 80, 160} with the time unit: slots, ms, us, 10 ms 20 ms, SSB periodicity and so on.

In an embodiment, the time window is between the timer starting and expiring, which is triggered via SIB, SIB1, MIB, and/or PBCH payload.

In an embodiment, length of the time window is obtained based on SFN, e.g., SFN_{c}mod X=0, X can be 160, 80 or other values.

### Embodiment 3

In an embodiment, an indication for activating or deactivating decoding/monitoring/combining of the repeatedly transmitted PDCCHs is determined by one or more indications in at least one of an SIB or an MIB.

In an embodiment, with X ms (e.g., X=40 ms, or 80 ms), 1 indicating bit or 2 indicating bits in the MIB may be used to indicate whether the PDCCH should be repeatedly transmitted or whether the UE should expect and/or monitor the repeatedly transmitted PDCCHs.

In an embodiment, with X ms (e.g., X=40 ms, or 80 ms), 1 indicating bit or 2 indicating bits in the MIB may be used to indicate in which slots (n_0 and/or n_0+1) the PDCCHs will be repeatedly transmitted, or the UE should expect and/or monitor the repeatedly transmitted PDCCHs.

In an embodiment, 1 indicating bit in the MIB may be used to indicate whether the feature of PDCCH decoding/monitoring/combining is supported. The PDCCH may be used to schedule the SIB1 or OSI message.

In an embodiment, the 1 indicating bit or 2 indicating bits in the MIB described above may be a reserved bit in MIB, or the PBCH payload bits ā_{Ā+6}, ā_{Ā+7}. For example, the 1 indicating bit may be from 1 reserved bit in the MIB, or the PBCH payload bit ā_{Ā+6}, or the PBCH payload bit ā_{Ā+7}. For example, 2 indicating bits may be from the PBCH payload bit ā_{Ā+6}, and the PBCH payload bit ā_{Ā+7}.

In an embodiment, an indication for activating or deactivating decoding/monitoring/combining of the repeatedly transmitted PDCCHs is determined by at least one of the following conditions:
a bandwidth of a CORESET #0 is larger than a maximum channel bandwidth of the second type wireless communication node;
the maximum channel bandwidth of the second type wireless communication node is less than a system bandwidth or a transmission bandwidth;
and/or the second type wireless communication node is allowed to access to a network or a cell.

In an embodiment, in predefined, configured, or indicated PDCCH occasions, the transmitted PDCCH may have the same DCI information.

In an embodiment, if the indications with indicating bits in the SIB1 described above are less than 3bits, the indications may be applied to the MIB.

### Embodiment 4

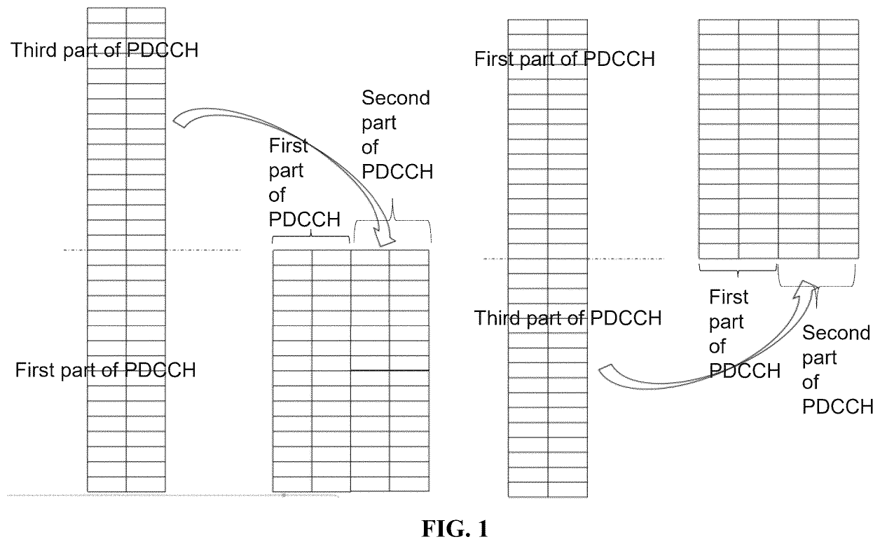

In an embodiment, the wireless communication method further comprising:
receiving, by the second type wireless communication node with a maximum channel bandwidth or a maximum physical resource block, PRB, numbers, a first part (see FIGS. 1 to 3) of a PDCCH in first defined symbols and a second part (see FIGS. 1 to 3) of the PDCCH in second defined symbols.

In an embodiment, a frequency location of the second part of the PDCCH is within the frequency location of the first part of the PDCCH.

In an embodiment, a bandwidth of the first part of the PDCCH and the second part of the PDCCH is no more than the maximum channel bandwidth of the second type wireless communication node or a PRB number of the first part of the PDCCH and the second part of the PDCCH is no more than the maximum PRB number of the second type wireless communication node.

In an embodiment, a third part (see FIGS. 1 to 3) of the PDCCH is defined in the first defined symbols and a frequency domain resource assignment, FDRA, of the first part of the PDCCH and the third part of the PDCCH is indicated via an MIB.

In an embodiment, wherein a third part of the PDCCH is defined in the first defined symbols, and a frequency location of the third part of the PDCCH is different from a frequency location of the second part of the PDCCH.

In an embodiment, the frequency location of the second part of the PDCCH is the M RBs in frequency indicated via an FDRA for the first part of the PDCCH and the third part of the PDCCH, e.g., the last M RBs in frequency indicated via the FDRA, or M RBs in the middle in frequency indicated via the FDRA, wherein M is an integer.

In an embodiment, for the CORESET #0 with 24 PRBs (physical resource blocks), if the UE can receive 12 PRBs, the mapping configuration as shown in FIG. 1 can be considered for UE receiving.

In FIG. 1, the M RBs (resource blocks) with RB index 0 to x1 (or x1 to N−1) with the first defined symbols may be mapped into the RBs with RB index x1+1 to N−1 (or 0 to x1−1) in the second defined symbols, wherein N is the total RB number for the PDCCH (N may be 24, 48, or 96 for a subcarrier spacing (SCS) with 15 KHz and N may be 24 or 48 for an SCS with 30KHZ).

In an embodiment, x1 may be configured via the SIB or predefined as 11 or 12 or 24 or 25. Further, the second defined symbols may be configured or indicated via the SIB or the MIB or be predefined. For example, the second defined symbols are the consecutive symbols with the same number after the first defined symbol, where the first defined symbols are the PDCCH symbols defined via the MIB pdcch-ConfigSIB1.

In an embodiment, for a PDCCH with an SCS of 15KHZ with 2 symbols, the UE may receive 25 RBs. If x1=24, the first 24 RBs are remained and the RB with index 24 to 47 may be mapped into the subsequent 2 symbols with the RB index 0 to 23.

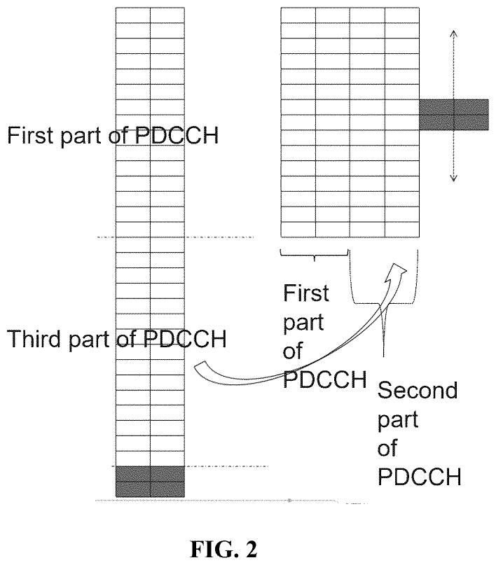

In an embodiment, the UE may receive 11 RBs for a PDCCH with an SCS of 30KHZ. An exemplary mapping configuration is shown in FIG. 2. As shown in FIG. 2, for the PDCCH with 24 RBs and 2 symbols, the first 11 RBs may be remained in the first defined symbols, the following 11 RBs may be mapped into the RBs with indexes 0 to 10 and with the second defined symbols, The remaining RBs and resources may not be transmitted or punctured.

In some embodiments, part of RBs with the first defined symbols are remained, a part of RBs is mapped within the RB range of the remained part with the second defined symbols, and the remained RBs and resources are not mapped or transmitted or are punctured.

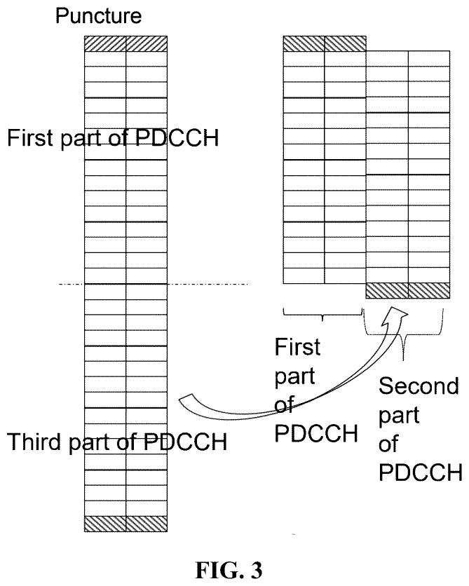

Another exemplary mapping configuration is shown in FIG. 3. As illustrated in FIG. 3, the RBs with the highest or lowest frequency may not be mapped or transmitted or may be punctured.

### Embodiment 5

In an embodiment, the timing relationship based on the mapping method may be as below.

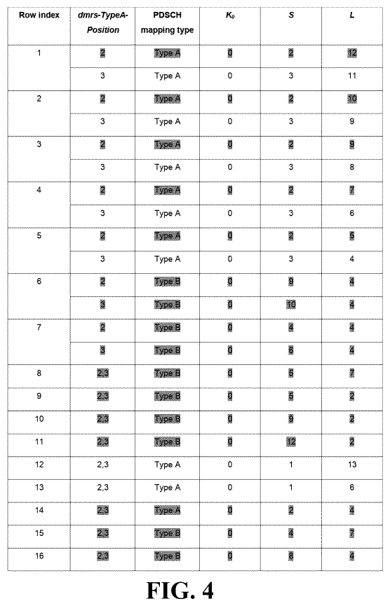

In an embodiment, for 15 KHz SCS CORESET #0 with 48 PRB or for 30 Khz CORESET #0 with 24 RB, the TDRA indication may be limited within an agreed part (e.g., the configurations in FIG. 4 with gray background).

In an embodiment, for 15 KHz SCS CORESET #0 with 48 PRB or for 30 Khz CORESET #0 with 24 RB, the TDRA indication may indicate the S should be 2, 4, and no less than 6.

In an embodiment, the table in FIG. 4 shows the default PDSCH time domain resource allocation TDRA for the normal CP (control plane). In FIG. 4, the indexed row defines the slot offset K0, the start and length indicator SLIV (e.g., the start symbol S) and the allocation length L.

### Embodiment 6

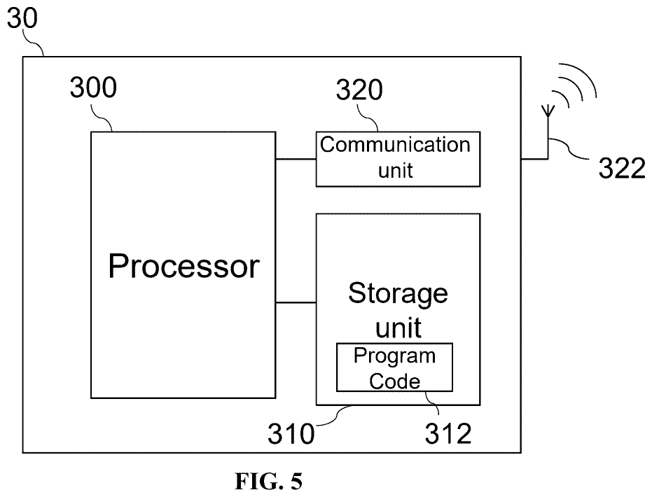

FIG. 5 relates to a diagram of a wireless communication terminal 30 (e.g., a terminal node, a terminal device, a second type wireless communication node) according to an embodiment of the present disclosure. The wireless communication terminal 30 may be a tag, a mobile phone, a laptop, a tablet computer, an electronic book or a portable computer system and is not limited herein. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may be a transceiver and be used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a first type wireless communication node (e.g., a base station).

In some embodiments, the wireless communication terminal 30 may be used to perform the operations of the UE described above. In some embodiments, the processor 300 and the communication unit 320 collaboratively perform the operations described above. For example, the processor 300 performs operations and transmits or receives signals, message, and/or information through the communication unit 320.

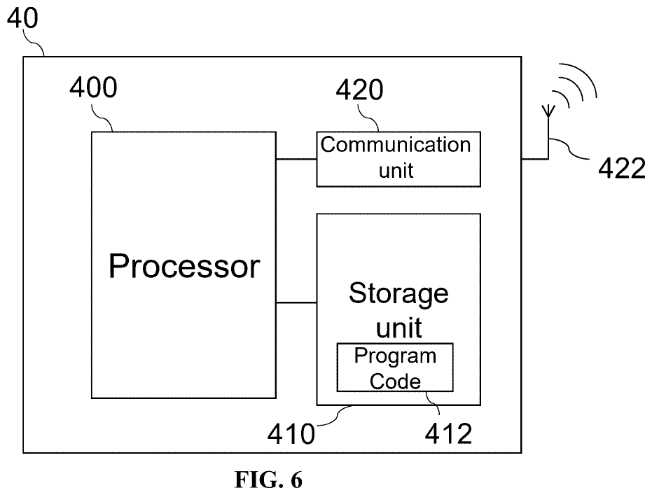

FIG. 6 relates to a diagram of a wireless communication node 40 (e.g., a network device or a second type wireless communication node) according to an embodiment of the present disclosure. The wireless communication node 40 may be a user equipment (UE), a satellite, a base station (BS), a gNB, a network entity, a Mobility Management Entity (MME), Serving Gateway (S-GW), Packet Data Network (PDN) Gateway (P-GW), a radio access network (RAN), a next generation RAN (NG-RAN), a data network, a core network, a communication node in the core network, or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

In some embodiments, the wireless communication node 40 may be used to perform the operations of the BS or the gNB described above. In some embodiments, the processor 400 and the communication unit 420 collaboratively perform the operations described above. For example, the processor 400 performs operations and transmits or receives signals through the communication unit 420.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

I/We claim:

1. A wireless communication method comprising:
receiving, by a second type wireless communication node from a first type wireless communication node, control information via repeatedly transmitted physical downlink control channels, PDCCHs, in one or more occasions.

2. The wireless communication method of claim 1, wherein the repeatedly transmitted PDCCHs comprises Type0 PDCCHs, Type0A PDCCHs, TypeOB PDCCHs, Type1 PDCCHs, or Type2 PDCCHs, wherein the second type wireless communication node monitors the repeatedly transmitted PDCCHs on one or more slots periodically, or the second type wireless communication node assumes or expects the PDCCHs are repeatedly transmitted on the one or more slots periodically,
wherein the occasions are predetermined or determined based on at least one of slot n0 or slot n0+1 for the second type wireless communication node monitoring the PDCCHs in a Type0-PDCCH CSS set, and
wherein the repeatedly transmitted PDCCHs can be transmitted on occasions in slot n0 associated to a same SSB index in different SSB burst sets, or the repeatedly transmitted PDCCHs can be transmitted on occasions in slot n0+1 associated to a same SSB index in different SSB burst sets; or the repeatedly transmitted PDCCHs can be transmitted on occasions in slots n0 and n0+1 associated to a same SSB index in different SSB burst set.

3. The wireless communication method of claim 2, wherein a search space set for transmitting the PDCCHs in at least one of slots n0 or n0+1 is predetermined, the second type wireless communication node assumed, the second type wireless communication node expected, or determined by one or more indications in at least one of a system information block, SIB, including SIB1, or a master information block, MIB, and
wherein the PDCCHs are repeatedly transmitted on all search space sets based to a Synchronization Signal/PBCH block, SSB, index on the slot n₀ or n₀+1; or
wherein the PDCCHs are repeatedly transmitted on a first search space set or a second search space set on the slot n₀ or n₀+1.

4. The wireless communication method of claim 1, wherein a periodicity for the repeatedly transmitted PDCCHs is predetermined, the second type wireless communication node assumed, the second type wireless communication node expected, or determined by one or more indications in at least one of a system information block, SIB, including a system information block #1, SIB1, or a master information block, MIB, and
wherein the periodicity indicated via the MIB or the SIB is larger than or equal to the periodicity of SSB for a cell.

5. The wireless communication method of claim 1, wherein the second type wireless communication node monitors the repeatedly transmitted PDCCHs in different occasions according to at least one of:
one or more first indexes;
one or more PDCCH candidate; or
one or more aggregation levels, ALS;
wherein one of the first indexes comprise at least one of a Control Channel Element, CCE, index for an AL L, or an index offset i for the AL L, and i=0, . . . , L−1,
wherein one of the PDCCH candidates comprises m_{s,n}_{_{Cl}}^{(L)}, m_{s,n}_{_{Cl}}^{(L)}=0, . . . , M_{s,n}_{_{Cl}}^{(L)}−1, wherein M_{s,n}_{_{Cl}}^{(L)} is a number of PDCCH candidates the second type wireless communication node is configured to monitor for the aggregation level L of a search space set s for a serving cell corresponding to n_{Cl}, and
wherein at least one of the first indexes, the PDCCH candidates, or the ALs for repeated PDCCH in different occasions are predetermined, the second type wireless communication node assumed, the second type wireless communication node expected, or determined by one or more indications in at least one of an SIB or an MIB.

6. The wireless communication method of claim 5,
wherein the second type wireless communication node monitors the repeatedly transmitted PDCCHs in different occasions with a same one of the first indexes, and a same one of the PDCCH candidates for the one or more AL, or
wherein the second type wireless communication node monitors the repeatedly transmitted PDCCHs in different occasions with multiple same indexes from the first indexes, and multiple same candidates from the PDCCH candidates for the one or more ALs, or
wherein the second type wireless communication node monitors the repeatedly transmitted PDCCHs in different occasions with different ones of the first indexes, or different ones of the PDCCH candidates for the one or more AL,
wherein the second type wireless communication node monitors the repeatedly transmitted PDCCHs in different occasions based on the one or more PDCCH candidates for the one or more ALs; or
wherein the second type wireless communication node monitors the repeatedly transmitted PDCCHs in different occasions based on one or more same indexes from the first indexes for the one or more ALs.

7. The wireless communication method of claim 1, wherein a length of a time window comprises at least one of the following:
a period of time;
a period of time based on timer;
a period of time based on an SSB periodicity or 20 milliseconds;
a period of time based on a system frame number, SFN;
a period of time based on time unit of microsecond, millisecond, or second; or
a number of the one or more occasions for the repeatedly transmitted PDCCHs;
and wherein the length of the time window is based on one or more indications in fields of a MIB.

8. The wireless communication method of claim 1, wherein an indication for activating or deactivating monitoring or decoding of the repeatedly transmitted PDCCHs is determined by at least one of the following conditions:
a bandwidth of a CORESET #0 is larger than a maximum channel bandwidth of the second type wireless communication node;
the maximum channel bandwidth of the second type wireless communication node is less than a system bandwidth or a transmission bandwidth;
and the second type wireless communication node is allowed to access to a network or a cell.

9. The wireless communication method of claim 1, further comprising,
receiving, by the second type wireless communication node with a maximum channel bandwidth or a maximum physical resource block, PRB, numbers, a first part of a PDCCH in first defined symbols and a second part of the PDCCH in second defined symbols;
wherein a frequency location of the second part of the PDCCH is within the frequency location of the first part of the PDCCH;
wherein a bandwidth of the first part of the PDCCH and the second part of the PDCCH are no more than the maximum channel bandwidth of the second type wireless communication node or a PRB number of the first part of the PDCCH and the second part of the PDCCH are no more than the maximum PRB number of the second type wireless communication node;
wherein a third part of the PDCCH is defined in the first defined symbols and a frequency domain resource assignment, FDRA, of the first part of the PDCCH and the third part of the PDCCH is indicated via an MIB;
wherein a third part of the PDCCH is defined in the first defined symbols, and a frequency location of the third part of the PDCCH is different from a frequency location of the second part of the PDCCH; and
wherein the frequency location of the second part of the PDCCH is M RBs in frequency indicated via an FDRA for the first part of the PDCCH and the third part of the PDCCH, wherein preferably last M RBs in frequency indicated via the FDRA, or M RBs in a middle in frequency indicated via the FDRA, wherein M is an integer.

10. A wireless communication method comprising:
transmitting, by a first type wireless communication node to a second type wireless communication node, control information via repeatedly transmitted physical downlink control channels, PDCCHs, in one or more occasions.

11. The wireless communication method of claim 10, wherein the repeatedly transmitted PDCCHs comprises Type0 PDCCHs, Type0A PDCCHs, TypeOB PDCCHs, Type1 PDCCHs, or Type2 PDCCHs, wherein the first type wireless communication node transmits the control information via the repeatedly transmitted PDCCHs on one or more slots periodically,
wherein the occasions are predetermined or determined based on at least one of slot n0 or slot n0+1 for the first type wireless communication node transmitting the control information via the PDCCHs in a Type0-PDCCH CSS set, and
wherein the repeatedly transmitted PDCCHs can be transmitted on occasions in slot n0 associated to a same SSB index in different SSB burst sets, or the repeatedly transmitted PDCCHs can be transmitted on occasions in slot n0+1 associated to a same SSB index in different SSB burst sets; or the repeatedly transmitted PDCCHs can be transmitted on occasions in slots n0 and n0+1 associated to a same SSB index in different SSB burst set.

12. The wireless communication method of claim 11, wherein a search space set for transmitting the PDCCHs in at least one of slots n0 or n0+1 is predetermined or determined by one or more indications in at least one of a system information block, SIB, including SIB1, or a master information block, MIB, and
wherein the PDCCHs are repeatedly transmitted on all search space sets based to a Synchronization Signal/PBCH block, SSB, index on the slot n₀ or n₀+1; or
wherein the PDCCHs are repeatedly transmitted on a first search space set or a second search space set on the slot n₀ or n₀+1.

13. The wireless communication method of claim 10, wherein a periodicity for the repeatedly transmitted PDCCHs is predetermined or determined by one or more indications in at least one of a system information block, SIB, including a system information block #1, SIB1, or a master information block, MIB, and wherein the periodicity indicated via the MIB or the SIB is larger than or equal to the periodicity of SSB for a cell.

14. The wireless communication method of claim 10, wherein the first type wireless communication node transmits the control information via the repeatedly transmitted PDCCHs in different occasions according to at least one of:
one or more first indexes;
one or more PDCCH candidate; or
one or more aggregation levels, ALS;
wherein one of the first indexes comprise at least one of a Control Channel Element, CCE, index for an AL L, or an index offset i for the AL L, and i=0, . . . , L−1,
wherein one of the PDCCH candidates comprises m_{s,n}_{_{Cl}}^{(L)}, m_{s,n}_{_{Cl}}^{(L)}=0, . . . , M_{s,n}_{_{Cl}}^{(L)}−1, wherein M_{s,n}_{_{Cl}}^{(L)} is a number of PDCCH candidates the first type wireless communication node is configured to transmits the control information for the aggregation level L of a search space set s for a serving cell corresponding to n_{Cl}, and
wherein at least one of the first indexes, the PDCCH candidates, or the ALs for repeated PDCCH in different occasions are predetermined or determined by one or more indications in at least one of an SIB or an MIB.

15. The wireless communication method of claim 14,
wherein the first type wireless communication node transmits the control information via the repeatedly transmitted PDCCHs in different occasions with a same one of the first indexes, and a same one of the PDCCH candidates for the one or more AL, or
wherein the first type wireless communication node transmits the control information via the repeatedly transmitted PDCCHs in different occasions with multiple same indexes from the first indexes, and multiple same candidates from the PDCCH candidates for the one or more ALs, or
wherein the first type wireless communication node transmits the control information via the repeatedly transmitted PDCCHs in different occasions based on the one or more PDCCH candidates for the one or more ALs; or
wherein the first type wireless communication node transmits the control information via the repeatedly transmitted PDCCHs in different occasions based on one or more same indexes from the first indexes for the one or more ALs.

16. The wireless communication method of claim 14, wherein the first type wireless communication node transmits the control information via the repeatedly transmitted PDCCHs in different occasions with different ones of the first indexes, or different ones of the PDCCH candidates for the one or more AL.

17. The wireless communication method of claim 10, wherein a length of a time window comprises at least one of the following:
a period of time;
a period of time based on timer;
a period of time based on an SSB periodicity or 20 milliseconds;
a period of time based on a system frame number, SFN;
a period of time based on time unit of microsecond, millisecond, or second; or
a number of the one or more occasions for the repeatedly transmitted PDCCHs;
and wherein the length of the time window is based on one or more indications in fields of a MIB.

18. The wireless communication method of claim 10, further comprising,
transmitting, by the first type wireless communication node to the second type wireless communication node with a maximum channel bandwidth or a maximum physical resource block, PRB, numbers, a first part of a PDCCH in first defined symbols and a second part of the PDCCH in second defined symbols;
wherein a frequency location of the second part of the PDCCH is within the frequency location of the first part of the PDCCH; and
wherein a bandwidth of the first part of the PDCCH and the second part of the PDCCH is no more than the maximum channel bandwidth of the second type wireless communication node or a PRB number of the first part of the PDCCH and the second part of the PDCCH is no more than the maximum PRB number of the second type wireless communication node.

19. A wireless communication node, comprising:
a communication unit; and
at least one processor configured to: receive, from a first type wireless communication node, control information via repeatedly transmitted physical downlink control channels, PDCCHs, in one or more occasions.

20. A wireless communication terminal, comprising:
a communication unit; and.
